(19) United States
(12) Patent Application Publication
(10) Pub. No.: US 2006/0224459 A1
(43) Pub. Date: Oct. 5, 2006

(54) Incoming/outgoing goods management system and incoming/outgoing goods management method

(75) Inventors: Koji Aramaki, Tokyo (JP); Kei Suzuki, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/325,573

(22) Filed: Jan. 5, 2006

(30) Foreign Application Priority Data
Mar. 30, 2005 (JP) 2005-096706

(51) Int. Cl. G06Q 20/00; G06G 1/14

(52) U.S. Cl. 705/22

(57) ABSTRACT

An incoming/outgoing goods management system showing the stock status of goods and the details of the incoming/outgoing goods work without delay. The gross weight of goods, and an unopened goods package and open goods package which store the goods measured by a weight sensor, and an ID tag attached to a package and ID tag carried by a worker read by an ID reader, are combined with various information stored by a storage part 145, so the incoming/outgoing goods work situation or inventory status can be appreciated promptly, a detailed check of compliance between plans and achievement can be performed, and required working command and warnings can be given to workers and managers so as to streamline the work.

### CLAIM OF PRIORITY

The present application claims priority from Japanese application JP 2005-096706 filed on Mar. 30, 2005, the content of which is hereby incorporated by reference into this application.

### FIELD OF THE INVENTION

This invention relates to an incoming/outgoing goods management system.

### BACKGROUND OF THE INVENTION

A function to provide a user with inventory information on goods stored for different uses is much needed in various industries wherein supply and consumption of goods are repeated on a daily basis.

JP-A No. 344146/2003 (pp. 4-8, FIG. 1, FIGS. 3-4) discloses a weight measuring device and an object number measurement system which uses this device. The weight measuring device outputs information which relates an object weight measured by a weight sensor to an ID, and this system has a function which computes and displays a number of objects on a controlling device by dividing the weight information forwarded to the controlling device by a unit weight stored beforehand. Since it acquires information which connects the object weight and ID for each type of object, in addition to a function which notifies the present number of objects, there is also a function which reports whether there was a change in the number of objects for each type of object.

JP-A No. 306186/2003 (pp. 4-10, FIG. 1, FIG. 9, FIG. 14) discloses a bicycle with an RFID tag, a bicycle management system and a bicycle management method. In this system, any one of information which specifies the bicycle, the bicycle's owner or various attribute information is recorded on the RFID tag fixed to the bicycle frame. This information is read by a RFID reader/writer, and it is verified whether the bicycle is allowed to enter and leave by comparing with information recorded beforehand recorded on a database server. This bicycle management system also has a function in which opening and closing of the entrance and exit gates of a bicycle parking lot are controlled.

### SUMMARY OF THE INVENTION

However, a function to verify in real time whether or not incoming/outgoing work is correct, i.e., whether or not preplanned details match the work details being carried out, is also important. For example, in an electronic device assembly plant, there are many examples wherein only workers with suitable training are permitted to handle fragile precision components and expensive parts. In medical-related industries, there are also cases where for example only officially qualified personnel are permitted to handle specific goods such as deadly poisons. By not permitting those who do not have the required technical knowledge or skill to perform the work, workers are prevented from performing the wrong actions intentionally or due to negligence, which is often done to avoid losses due to damaged goods or enhance safety. In order to verify such compliance, a means which can detect the work which is actually performed, and a means to compare the detected information with the planned work details in real time, is required.

In a manufacturing facility with a limited production of a wide variety of goods, the consumption amount of each goods article is different each day, and it is common for the incoming/outgoing timing and incoming/outgoing amount of goods to be irregular. Therefore, for a company, from the viewpoint of reducing unnecessary stock and avoiding short supply of required goods, a precise grasp of the incoming/outgoing status of a particular goods article and stocktaking to verify its status play an important role.

The object number measurement system defined in JP-A No. 344146/2003 (pp. 4-8, FIG. 1, FIGS. 3-4) has limited use when applied to inventory management of goods accompanying the use of goods in the work flow. Namely, this system is used only to measure the inventory volume for each goods article and the existence or otherwise of incoming/outgoing goods work operations, and it has no function to verify in real time whether incoming/outgoing goods work has been carried out as planned. Using only the functions of this system, it cannot be confirmed whether or not the number of goods articles and the incoming/outgoing goods handled by each worker are compliant as regards the actual work carried out and the work details planned beforehand. Hence, there is no means to issue a warning if needed, nor any means to issue suitable working commands.

On the other hand, although the bicycle management system disclosed in JP-A No. 306186/2003 (pp. 4-10, FIG. 1, FIG. 9, FIG. 14) does have a function to confirm whether or not a procedure applied to managed goods complies with prerecorded conditions, it cannot be determined whether or not a worker handling goods is using the goods appropriately during work flow, or whether or not there is compliance between the number of goods articles and the work flow. Moreover, it aims to provide managed goods with ID information maintenance means, and to manage goods used as permanent assets. Therefore, when applied to management of goods consumed by the work flow, a step is required to add an ID information maintenance means to each goods during warehousing, and a step is required to remove the ID information maintenance means to return the goods to their original state when they are shipped out. In a work flow which consumes a large amount of goods, these addition and removal steps greatly increase the overall cost of the work. Therefore, some means is required to grasp, in real time, whether incoming/outgoing goods processing and stocktaking corresponds with the inventory volume of goods as planned without providing the goods itself with an ID information maintenance means.

It is therefore an object of the invention, in order to resolve the abovementioned problems, to provide an incoming/outgoing goods management device and incoming/outgoing goods management method having a function to notify a user of inventory volume by measuring the amount of goods, and a function which confirms, in real time, whether incoming/outgoing of goods complies with the work plan.

An outline of the present invention which attains the object, as disclosed in the present application, will now be described. The present invention comprises a first sensor which measures a goods inventory volume, a first ID tag having information which specifies the goods and a second ID tag which shows information about a worker authorized to handle the goods, measured values acquired from the sensor and information in the first and second ID tags being compared during the work which handles the goods.

According to this invention, it is possible to determine, in real time, whether the right worker is performing the right procedure during work flow.

### BRIEF DESCRIPTION OF THE DRAWINGS

FIG. 1 is a diagram showing an example of the construction of an incoming/outgoing goods management device according to one embodiment of the invention;

FIG. 2 is a diagram showing an example of information stored by the storage part according to one embodiment of the invention;

FIG. 3 is a diagram showing an example of constant information for each goods type code according to one embodiment of the invention;

FIG. 4 is a diagram showing an example of the constant information for each package type according to one embodiment of the invention;

FIG. 5 is a diagram showing an example of information for each order number according to one embodiment of the invention;

FIG. 6 is a diagram showing an example of information for each package ID according to one embodiment of the invention;

FIG. 7 is a diagram showing an example of inventory information for each goods type code according to one embodiment of the invention;

FIG. 8 is a diagram showing an example of incoming/outgoing planning information for each goods type code according to one embodiment of the invention;

FIG. 9 is a flow chart showing an example of an inspection work sequence according to one embodiment of the invention;

FIG. 10 is a flow chart showing an example of an incoming goods work sequence according to one embodiment of the invention;

FIG. 11 is a flow chart showing an example of an outgoing goods work sequence procedure according to one embodiment of the invention;

FIG. 12 is a flow chart showing an example of a stocktaking work sequence according to one embodiment of the invention;

FIG. 13 is a diagram showing the details of a communication pathway according to one embodiment of the invention; and

FIG. 14 is a diagram showing the details of a weight sensor and a wireless communications node according to one embodiment of the invention.

### DETAILED DESCRIPTION OF THE PREFERRED EMBODIMENTS

The details of the invention disclosed by the present application will now be described referring to the drawings.

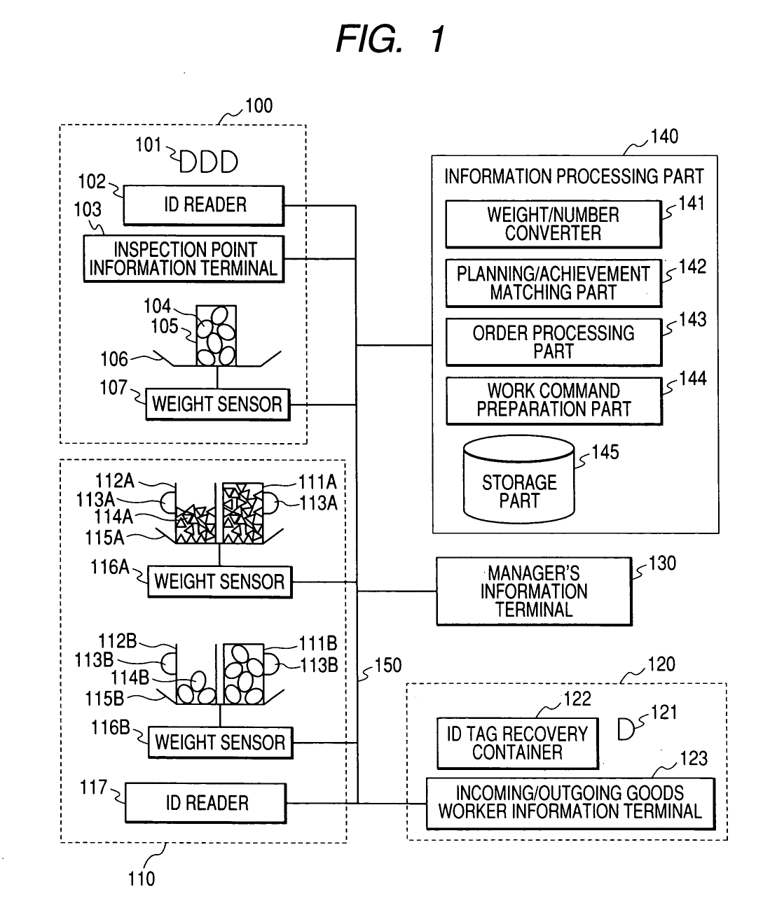

FIG. 1 is a figure showing the system configuration of one embodiment of the invention. This system is an example of a system wherein a manager can easily obtain information about incoming/outgoing goods status and stock status, and easily verify the difference between plans and achievements in a product assembly plant.

In a product assembly plant, there are one or more inspection points 100 and goods storage shelves 110, respectively. At the inspection point 100, there are respectively installed one or more of an unused ID tag 101, ID reader 102, inspection point information terminal 103 and weight sensor 107, and a case 106 is installed on each weight sensor 107. All goods 104 to be inspected are stored beforehand in an unopened goods package 105, and attachment of an ID tag, measurement of weight and various types of information registration are performed at the inspection point before warehousing of the goods according to the information processing flow during inspection (described hereafter). In FIG. 1, the goods article is shown as a solid, but a fluid may also be stored in the package.

A weight sensor is installed in the goods storage shelf 110 for each goods type code. In FIG. 1, in the case shown, two types of goods are stored, and two weight sensors 116A and 116B are installed. A case 115A is installed on the weight sensor 116A, zero or more unopened goods packages 111A, zero or one opened goods package 112A are stored in the case 115A, and goods are stored in each package. All the unopened goods packages 111A and opened goods packages 112A must have an ID tag 113A. Therefore, the weight sensor 116A can measure the weight of all the unopened goods packages 111A containing goods 114A and opened goods packages 112A, and the gross weight of all the ID tags 113A and case 115A.

Likewise, the weight sensor 116B can measure the weight of all the unopened goods packages 111B containing goods 114B and opened goods packages 112B, and the gross weight of all the ID tags 113B and cases 115B.

A worker who performs incoming/outgoing goods work with the goods storage shelf 110 always carries an incoming/outgoing goods worker identifier 120. The incoming/outgoing goods worker identifier 120 contains an ID tag 121 for identifying the worker who was authorized to handle the goods, ID tag recovery container 122 and information terminal 123 for incoming/outgoing goods workers. The details of incoming/outgoing goods work are described later.

In the goods storage shelf 110, one or more ID readers 117 are installed. These ID readers 117 can read the ID information of all the ID tags 113A, 113B inside the corresponding goods storage shelf 110. These ID readers 117 can also read the ID tag 121 carried by the corresponding worker in front of the goods storage shelf 110.

The weight sensors 107, 116A, 116B, ID readers 102, 117, inspection point information terminal 103 and information terminal 123 for incoming/outgoing goods workers are connected to a communication pathway 150. A manager's information terminal 130 and an information processing part 140 are also connected to the communication pathway 150. The devices connected to the communication pathway 150 can exchange information with each other. The communication pathway 150 may for example be a wired computer network, a wireless computer network or a combination thereof.

The manager can check the incoming/outgoing status of any goods, register planning information and receive notice of abnormalities by information input and output via the manager's information terminal 130. The information processing part 140 comprises a weight/number converter 141, a plan/achievement matching part 142, order processing part 143, work command preparation part 144 and storage part 145, stores the weight of the goods or package ID information, and performs predetermined processing based on the acquired information as described later. All or part of the manager's information terminal 130 and information processing part 140 may be situated in a different place from the product assembly plant where the goods are supplied and consumed.

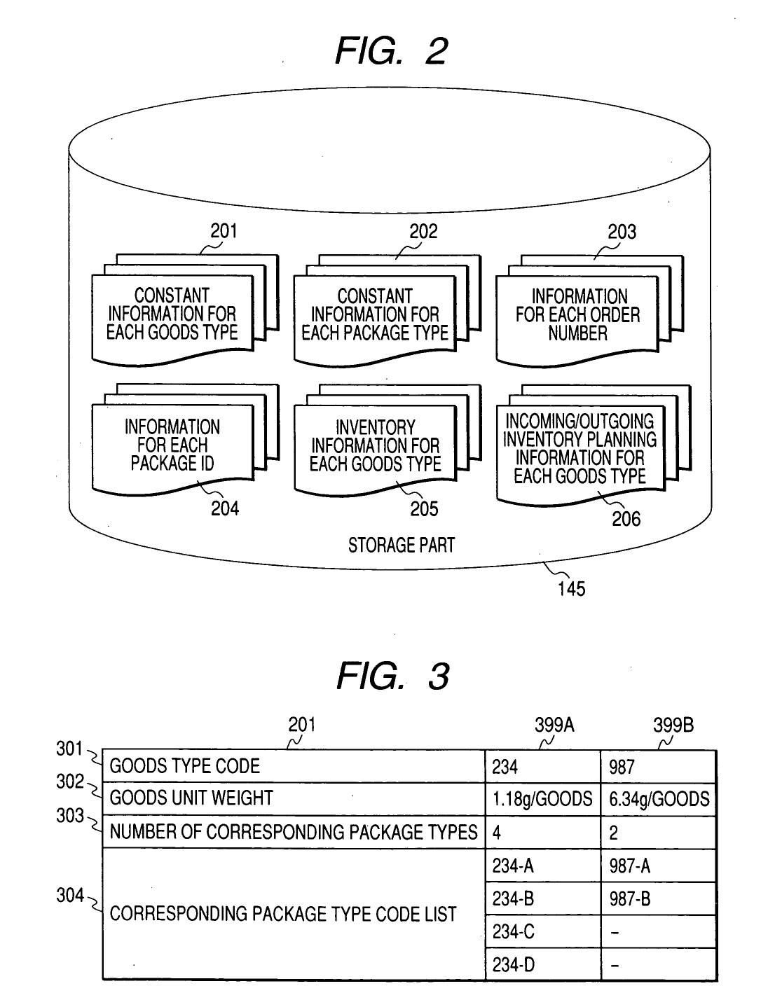

Next, the information stored by the storage part 145 will be described. As shown in FIG. 2, the information stored by the storage part 145 contains constant information 201 for each goods type, constant information 202 for each package type, information 203 for each order number, information 204 for each package ID, inventory information 205 for each goods type, and incoming/outgoing planning information 206 for each goods type.

As shown in FIG. 3, the constant information 201 for each goods type includes a goods type code 301, goods unit weight 302, number 303 of corresponding package types, and list 304 of corresponding package type codes.

For the codes mentioned in the list 304 of corresponding package type codes, the same codes as the package type codes 401 (described hereafter) contained in the constant information 202 for each package type, are used. As an example of the constant information 201 for each goods type, FIG. 3 shows Example 399A and Example 399B. In Example 399A, the goods type code is “234”, the goods unit weight is “1.18 g”, the number of corresponding package types is “4” and the corresponding package type codes are “234-A”, “234-B”, “234-C”, “234-D”. In Example 399B, the goods type code is “987”, the goods unit weight is “6.34 g”, the number of corresponding package types is “2” and the corresponding package type codes are “987-A”, “987-B”.

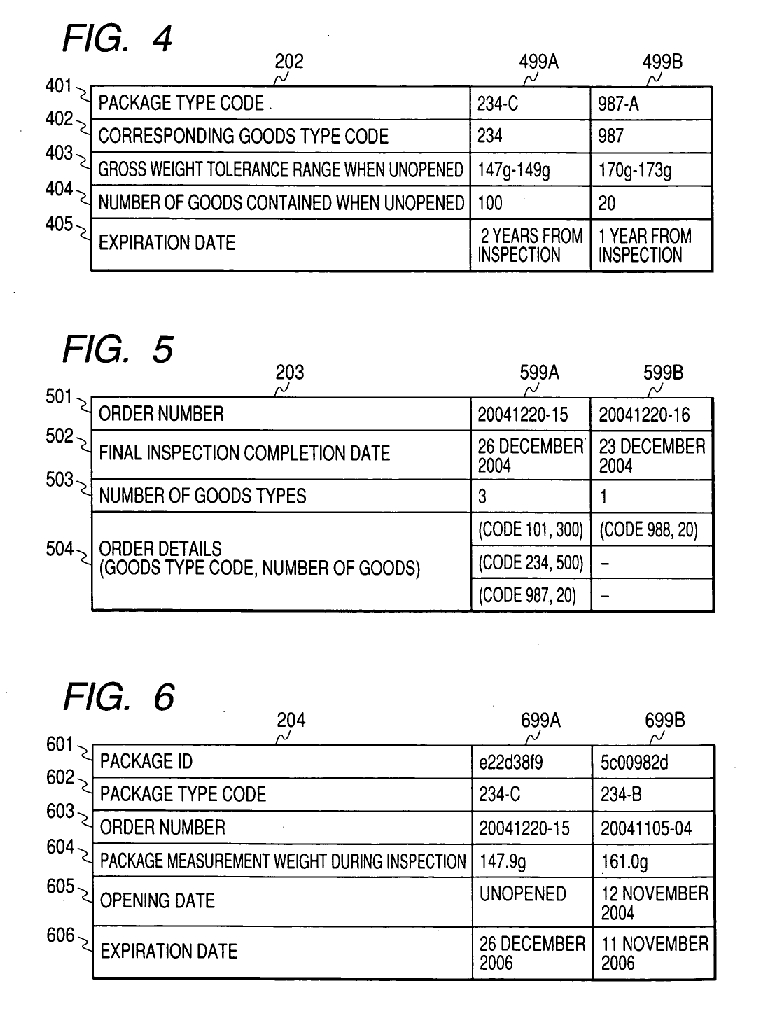

As shown in FIG. 4, the constant information 202 for each package type includes the package type code 401, corresponding goods type code 402, permissible range 403 of gross weight when unopened, number of goods 404 contained when unopened and expiration date 405. For the corresponding goods type code 402, the same code as the goods type code 301 contained in the constant information 201 for each goods type, is used. FIG. 4 shows Example 499A and Example 499B as examples of the constant information 202 for each package type. In Example 499A, the package type code is “234-C”, the corresponding goods type code is “234”, the permissible range of gross weight when unopened is “147 g_-149 g”, the number of goods contained in the unopened package is “100” and the expiration date is “2 years after inspection”. In Example 499B, the package type code is “987-A”, the corresponding goods type code is “987”, the permissible range of gross weight when unopened is “170 g-73 g”, the number of goods contained when unopened is “20” and the expiration date is “1 year after inspection”.

As shown in FIG. 5, the information 203 for each order number includes an order number 501, inspection completion date 502, number 503 of goods types and order details 504. The order details 504 contain a set of goods type codes and numbers of goods. For this goods type code, the same code is used as the code 301 contained in the constant information 201 for each goods type. FIG. 5 shows Example 599A and Example 599B as examples of the information 203 for each order number. In Example 599A, the order number is “20041220-15”, the inspection completion date is “26 Dec. 2004”, the number of goods types is “3” and the order details are “(Code 101, 300 pcs)” “(Code 234, 500 pcs)”, “(Code 987, 20 pcs)”. In Example 599B, the order number is “20041220-16”, the inspection completion date is “23 Dec. 2004”, the number of goods is “1” and the order details are “(Code 988, 20 pcs)”.

As shown in FIG. 6, the information 204 for each package ID includes information for specifying goods such as a package ID 601, package type code 602, order number 603, weight 604 of unopened package measured during inspection, opening date 605 and expiration date 606. For the package type code 602, the same code as the package type code 401 contained in the constant information 202 for each package type, is used. For the order number 603, the same code as the order number 501 contained in the information 203 for each order number, is used. When the package corresponding to this information is unopened, the opening date 605 is expressed by the value “unopened.” FIG. 6 shows Example 699A and Example 699B as specific examples of the information 204 for each package ID. In Example 699A, the package ID is “e22d38f9”, the package type code is “234-C” the order number is “20041220-15”, the weight of unopened package measured during inspection is “147.9 g”, and the opening date is expressed by the value “unopened” and the expiration date is “26 Dec. 2006. In Example 699B, the package ID is “5c00982d”, the package type code is “234-B”, the order number is “20041105-04”, the weight of unopened package measured during inspection is “161.0 g”, the opening date is 12 Nov. 2004” and the expiration date is “11 Nov. 2006”.

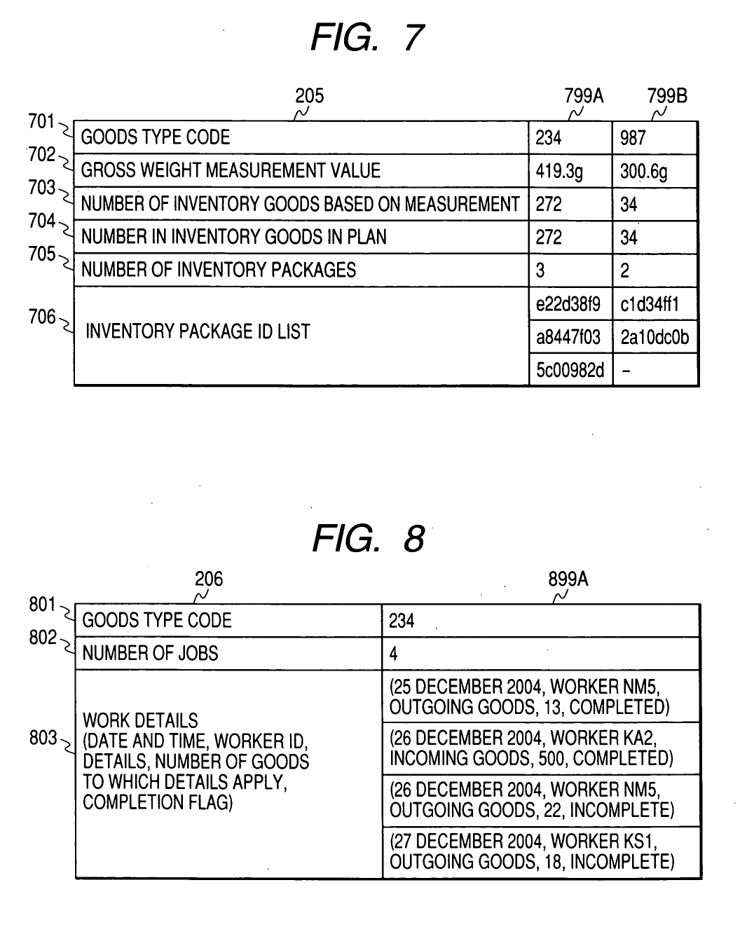

As shown in FIG. 7, inventory information 205 for each goods type includes a goods type code 701, measured value 702 of gross weight, number 703 of inventory goods based on measured weight, number 704 of inventory goods in plan, number 705 of inventory packages and list 706 of IDs of inventory packages. For the goods type code 701, the same code as the code 301 contained in the constant information 201 for each goods type, is used. For the IDs mentioned in the list 706 of IDs of inventory packages, the same ID as the package ID 601 contained in the information 204 for each package ID, is used. FIG. 7 shows Example 799A and Example 799B as specific examples of the inventory information 205 for each goods type. In Example 799A, the goods type code is “234”, the measured value of gross weight is “419.3 g”, the number of inventory goods based on measured weight is “272”, the number of inventory goods in plan is “272”, the number of inventory packages is 3 and the list of IDs of inventory packages is “e22d38f9, a8447f03, 5c00982d”. In Example 799B, the goods type code is “987”, the measured value of gross weight is “300.6 g”, the number of inventory goods based on measured weight is “34”, the number of inventory goods in plan is “34”, the number of inventory packages is “2” and the list of IDs of inventory packages is “c1d34ff1, 2a10dc0b”.

As shown in FIG. 8, incoming/outgoing planning information 206 for each goods type contains a goods type code 801, number 802 of work procedures and work details 803. The work details 803 contain a set of the date, worker ID, details, number of goods to which details apply and completion flag. For the goods type code 801, the same code as the goods type code 301 contained in the constant information 201 for each goods type, is used. FIG. 8 shows Example 899A as an example of incoming/outgoing planning information 206 for each goods type. In Example 899A, the goods type code is “234”, the number of work procedures is “4” and the work details are “(25 Dec. 2004, worker NM5, outgoing goods, 13, completed), “(26 Dec. 2004, worker KA2, incoming goods, 500, completed), “(26 Dec. 2004, worker NM5, outgoing goods, 22, incomplete) and “(27 Dec. 2004, worker KS1, outgoing goods, 18, incomplete).

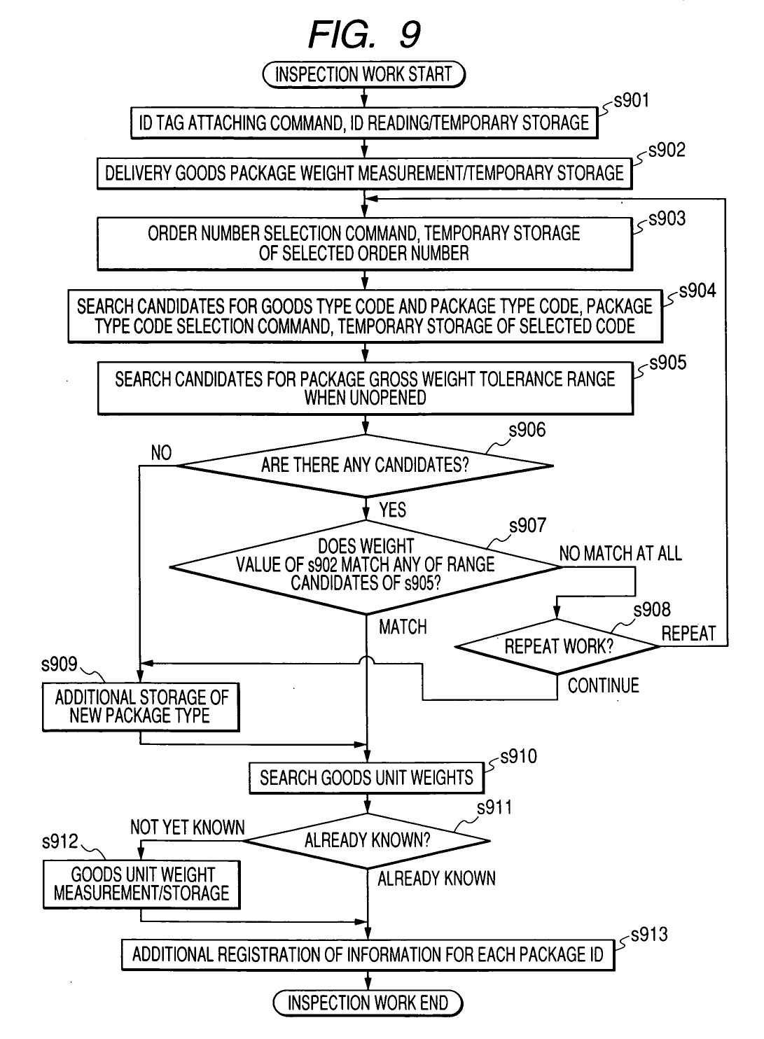

Above, the information inputted into the storage part was shown using FIG. 3-FIG. 8. Hereafter, the method of determining compliance in the respective work steps, i.e., inspection, incoming procedure, outgoing procedure and stocktaking flow, is shown using FIG. 9 to FIG. 12.

FIG. 9 is a flow chart which shows the sequence of inspection work performed on the goods packages supplied to the inspection point 100.

First, a message which specifies attaching the unused ID tag 101 to the supplied unopened goods package 105, and reading the ID by the ID reader 102, is displayed on the inspection point information terminal 103, and the ID read by the ID reader 102 is stored temporarily as a delivery goods package ID (Step s901).

Next, a message which specifies placing this unopened goods package 105 in the case 106 on the weight sensor 107 is displayed on the inspection point information terminal 103, and the value measured by the weight sensor 107 is stored temporarily as a delivery goods package weight (Step s902).

Next, a list of the information 203 for each order number, and a message which specifies selecting an order number corresponding to the supplied unopened package, are displayed on the inspection point information terminal 103, and the selected order number is stored temporarily (Step s903).

Based on this order number, candidates for the goods type code are searched from the information 203 for each order number in the storage part 145, the resulting list and a message which specifies selecting an order number corresponding to the supplied unopened package, are displayed on the inspection point information terminal 103, and the goods type code selected by a worker is stored temporarily (Step s904).

Based on this goods type code, candidates for the package type code and the permissible range of gross weight when unopened corresponding thereto are searched from the constant information 201 for each goods type in the storage part 145 and the constant information 202 for each package type (Step s905)

If the permissible range of gross weight when unopened cannot be obtained in the Step s905 (i.e., when not yet registered in the storage part 145), processing moves to a step s909 described later (Step s906).

If the delivery goods package weight measured in the Step s902 complies with any of the permissible ranges of gross weight when unopened searched in the Step s905, processing moves to a step s910 described later (Step s907).

If there is no compliance at all in the Step s907, there is a possibility that the work so far has an error, so a statement to the effect that there is no compliance and a message which asks whether or not to repeat the work, are displayed on the inspection point information terminal 103. If “repeat” is chosen, the processing moves to the Step s903 (Step s908).

When processing moves to the Step s909, it is interpreted as the appearance of an unregistered package type, one set of constant information for each package type is newly generated, and additional registration in the storage part 145 is performed. At this time, some items of the constant information for each package type are inputted by the worker via the inspection point information terminal 103 if required (Step s909).

In the Step s910, based on the goods type code stored temporarily in the Step s904, the goods unit weight is searched from the constant information 201 for each goods type in the storage part 145 (Step s910). When the goods unit weight has been obtained in the Step s910, processing moves to a step s913 described later (Step s911).

If the goods unit weight is not obtained in the Step s910, it is interpreted as the appearance of an unregistered goods type code, a message which specifies placing the unit amount of the goods in the case 106 on the weight sensor 107 is displayed on the inspection point information terminal 103, the value measured by the weight sensor 107 is linked with the goods type code stored temporarily in the Step s904 as the goods unit weight, and the constant information 201 for each goods type in the storage part 145 is updated (Step s912).

In the Step s913, one set of the information 204 is generated for each package ID, and is added to the storage part 145. At this time, the order number stored temporarily in the Step s906 is registered as the order number 603, the delivery goods package ID stored temporarily in the Step s902 is registered as the package ID 601, the delivery goods package weight stored temporarily in the Step s904 is registered as the weight 604 of unopened package measured during inspection, and inspection work is terminated (Step s913).

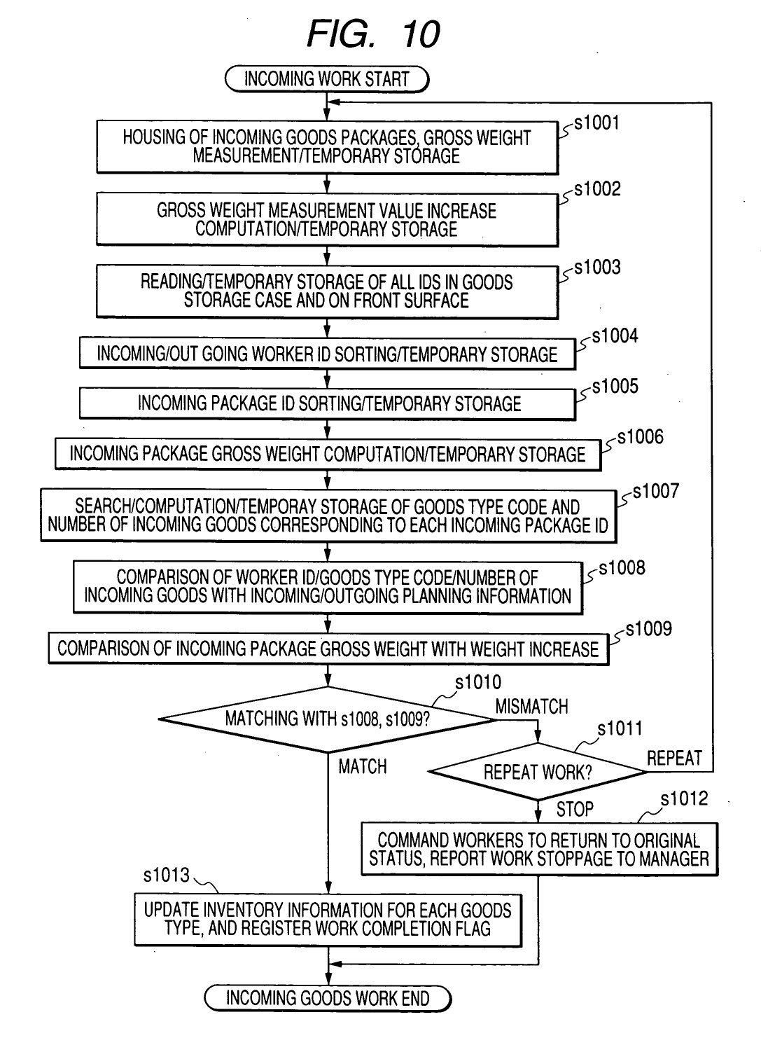

FIG. 10 is a flow chart which shows the sequence of warehousing incoming unopened goods packages in the goods storage shelf 110.

First, a message which specifies storing unopened goods packages 111A for warehousing in the predetermined case 115A is displayed on the information terminal 123 for incoming/outgoing goods workers, and the weight measured by a weight sensor 116A is stored temporarily as the measured value of gross weight (Step s1001). The measured value 702 of gross weight described by the inventory information 205 for each goods type stored by the storage part 145 is subtracted from the measured value of gross weight stored temporarily in the Step s1001, and the result is stored temporarily as a weight increase fraction (Step s1002).

Next, the ID reader 117 performs ID reading, and all the read IDs are stored temporarily (Step s1003).

Among the IDs stored temporarily in the Step s1003, only the IDs showing workers are sorted and stored temporarily as incoming/outgoing worker IDs (Step s1004).

Among the IDs stored temporarily in the Step s1003, all IDs which are not contained in the list 706 of IDs of inventory packages in the inventory information 205 for each goods type stored by the storage part 145, are stored temporarily as incoming package IDs (Step s1005).

Based on the incoming package IDs stored temporarily in the Step s1005, the information 204 for each package ID is retrieved from the storage part 145, and the sum total of the weight 604 of unopened package measured during inspection described thereby is stored temporarily as an incoming package gross weight (Step s1006).

Based on the information 204 for each package ID searched in the Step s1006, the constant information 202 for each package type is searched from the storage part 145, the corresponding goods type codes 402 described thereby are stored temporarily, and the sum total of the number of goods 404 contained when unopened described therein is stored temporarily as a number of incoming goods (Step s1007).

A comparison is made as to whether or not the incoming/outgoing worker IDs stored temporarily in the Step s1004, the corresponding goods type codes 402 and the number of incoming goods stored temporarily in the Step s1007, match the goods type codes 801 and work details 803 described by the incoming/outgoing planning information 206 for each goods type stored by the storage part 145 (Step s1008).

The gross weight of incoming packages stored temporarily in the Step s1006 is compared with the weight increase stored temporarily in the Step s1002 (Step s1009).

When there is no mismatch in the result of the comparison obtained in the Step s1008 and Step s1009, processing moves to the Step s1013 described later (Step s1010). If there is a mismatch in the result of the comparison performed in the Step s1008 or Step s1009, there is a discrepancy in the work plan and work details, so the mismatched contents, and a message which specifies selection of whether to repeat the work or stop the work, are displayed on the information terminal 123 for incoming/outgoing goods workers, and when repeat of the work is selected by the worker, processing moves to the Step s1001 (Step s1011).

When stopping the work is selected in the Step s1011, a message which specifies returning the goods storage shelf to its original state at work start is displayed on the information terminal 123 for incoming/outgoing goods workers, a report which states that work was stopped is displayed on the manager's information terminal 130, and incoming goods work is terminated (Step s1012).

In the Step s1010, when there is no mismatch, each goods article of the inventory information 205 for each goods type stored by the storage part 145 and a completion flag of the incoming/outgoing planning information 206 for each goods type, are updated (Step s1013).

As shown in FIG. 10, in this embodiment, a goods inventory volume can be provided in real time. The weight of goods in storage can always be measured, the system provides a communication pathway which immediately transmits the measured weight value to an information processing part, and various information for conversion to a number of goods can be immediately referred to in the information processing part, so when information on the number of goods is required, this information can be measured/computed immediately.

Regarding the steps shown in FIG. 10, the work need not be performed in this sequence, for example, sorting of incoming/outgoing worker IDs and incoming package ID and temporary storage may be interchanged. The work flow can be changed to the extent that worker IDs, the number of inventory goods, number of plans and the weight still match,.

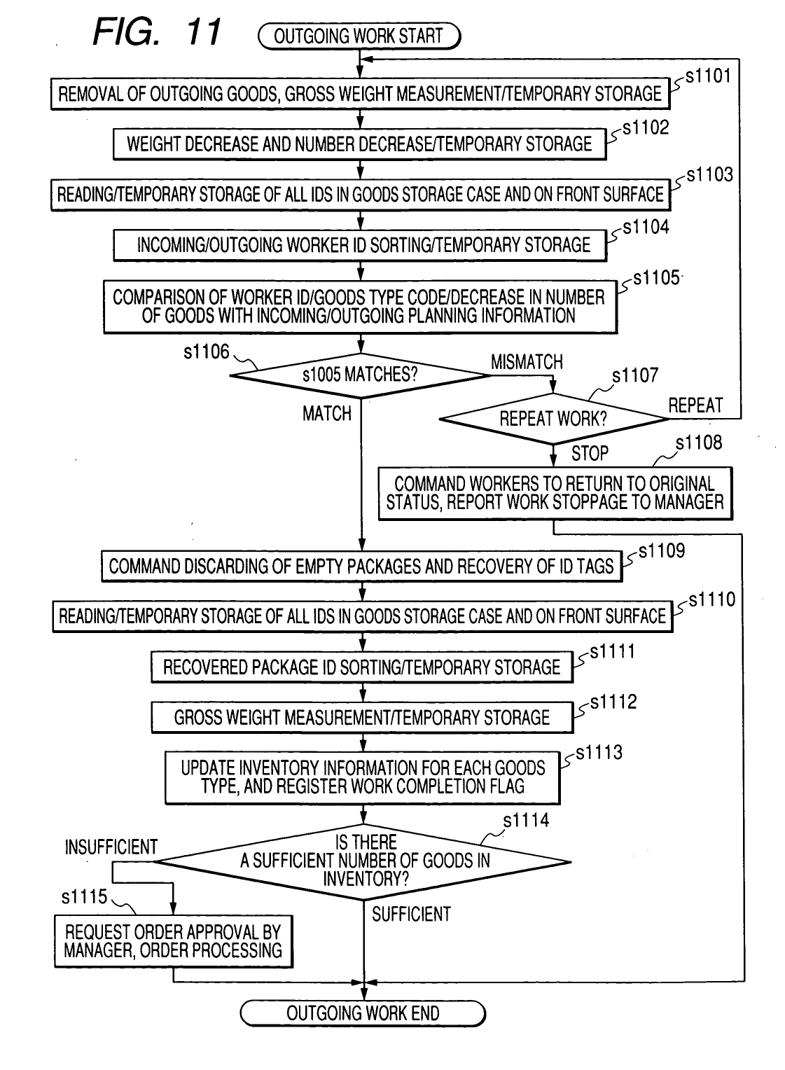

FIG. 11 is a flow chart which shows the outgoing goods work procedure applied to goods from the storage shelf 110. First, a message which specifies selecting goods 114A to become outgoing goods from the predetermined case 115A is displayed on the information terminal 123 for incoming/outgoing goods workers, and the weight measured by the weight sensor 116A is stored temporarily as the measured value of gross weight (Step s1101). The measured value of gross weight stored temporarily in the Step s1101 is subtracted from the measured value 702 of gross weight described by the inventory information 205 for each goods type stored by the storage part 145, and the result is stored temporarily as a weight decrease. The weight decrease is divided by the goods unit weight 302 described by the constant information 201 for each goods type stored in the storage part 145, and the result is stored temporarily as a number decrease (Step s1102).

Next, the ID reader 117 performs ID reading, and all the read IDs are stored temporarily (Step s1103). Among the IDs stored temporarily in the Step s1103, only IDs showing workers are sorted and stored temporarily as incoming/outgoing goods worker IDs (Step s1104).

A comparison is made as to whether or not the goods type codes, the incoming/outgoing worker IDs stored temporarily in the Step s1104 and the number decrease stored temporarily in the Step s1102, match the goods type codes 801 and work details 803 described by the incoming/outgoing planning information 206 for each goods type stored in the storage part 145 (Step s1005).

When there is no mismatch in the comparison result obtained in the Step s1105, processing moves to the Step s1109 described later (Step s1106).

If there is a mismatch in the result of the comparison performed in the Step s1105, there is a discrepancy in the work plan and work details, so the mismatched contents, and a message which specifies selection of whether to repeat the work or stop the work, are displayed on the information terminal 123 for incoming/outgoing goods workers, and when repeat of the work is selected by the worker, processing moves to the Step s1101 (Step s1107).

When stopping the work is selected in the Step s1107, a message which specifies returning the goods storage shelf to its original state at work start is displayed on the information terminal 123 for incoming/outgoing goods workers, a report which states that work was stopped is displayed on the manager's information terminal 130, and outgoing goods work is terminated (Step s1108).

When there is no mismatch in the Step s1105, if there is an empty package, a message which specifies discarding of the package from the case 115A and the recovery of the appended ID by the ID tag recovery container 122, are displayed on the information terminal 123 for incoming/outgoing goods workers, the system waits for input of an acknowledgement that recovery work is complete, and the processing moves to the Step s1110 (step s1109). By storing the ID tag in the ID tag recovery container, ID reading of the recovered ID tag by the ID reader 117 is prevented. The ID reader 117 then performs ID reading, and all the read IDs are stored temporarily (Step s1110).

The list 706 of IDs of inventory packages described by the inventory information 205 for each goods type stored in the storage part 145, is compared with all the IDs stored temporarily in the Step s1110, and package IDs which can no longer be read are stored temporarily as recovered package IDs (Step s1111).

Weight measurement is performed by the weight sensor 116A corresponding to outgoing goods, and the measured value is stored temporarily as the measured value of gross weight (Step s1112).

Based on the recovered package IDs stored temporarily in the Step s1111 and the gross weight stored temporarily in the Step s1112, each goods article of the inventory information 205 for each goods type stored by the storage part 145 is updated, and the completion flag for the incoming/outgoing planning information 206 for each goods type is registered (Step s1113).

If the number 703 of inventory goods based on the measured weight described by the inventory information 205 for each goods type stored by the storage part 145 exceeds a threshold specified beforehand, outgoing goods work is terminated (Step s1114).

If the number 703 of inventory goods based on the measured weight does not exceed the threshold specified beforehand in the Step s1114, a report to the effect that the inventory volume is inadequate and a message specifying placing of an order are displayed on the manager's information terminal 130, and if an intention to accept the order is inputted by the manager, ordering processing is automatically performed by the order processing part 143, and outgoing goods work is terminated (Step s1115).

As shown in FIG. 11, in this embodiment, it can be verified whether the worker who performs incoming/outgoing goods work and work details. comply with plans. The ID reader can read the information on the ID tag carried by the incoming/outgoing goods worker when work is performed. Since the system has a communication pathway which transmits information to the information processing part immediately, work plan information can be immediately looked up in the information processing part and a function is provided to detect the inventory volume of goods, plans can be matched with the work achievement. As a result, also when there is a possibility that the work has not been or may not be performed according to plan, suitable measures can be implemented at an early stage.

It is not necessary to perform work in the sequence of steps shown in FIG. 11, for example, the weight of outgoing goods can be checked by sorting and storing the IDs of incoming/outgoing goods workers. It will of course be understood that the number of outgoing goods, work plans and workers can be modified to the extent that compliance can still be obtained.

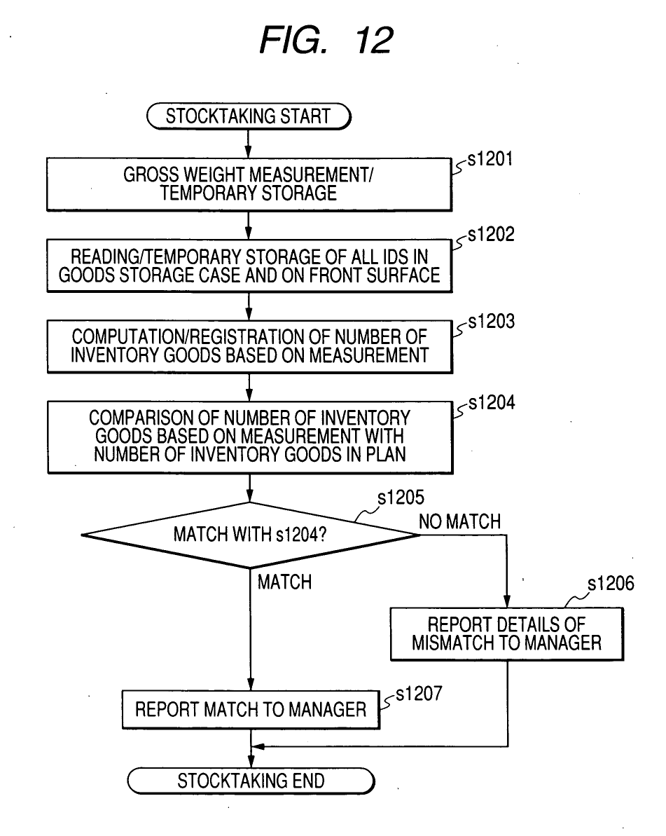

FIG. 12 is a flow chart which shows the stocktaking work sequence of the goods storage shelf 110 for one type of goods.

First, the weight measured by the weight sensor 116A corresponding to the goods 114A for stocktaking is stored temporarily as a measured value of gross weight (Step s1201). Next, the ID reader 117 performs ID reading, and all the read IDs are stored temporarily (Step s1202).

The goods unit weight 302 is searched from the constant information 201 for each goods type stored by the storage part 145. The list 706 of IDs of inventory packages described by the inventory information 205 for each goods type stored by the storage part 145 is searched, and the weight 604 of unopened package measured during inspection and the package type code 602 are searched from the information 204 for each package ID. Based on this package type code 602, the number of goods 404 contained when unopened is obtained from the constant information 202 for each package type. The weight of an empty container is computed by subtracting the product of the goods unit weight 302 and the number of goods 404 contained when unopened from the weight 604 of unopened package measured during inspection for each package ID. The sum total of the weight of empty containers is subtracted from the measured value of gross weight stored temporarily in the Step s1202, the number 703 of inventory goods based on the measured weight is computed by dividing this result by the goods unit weight 302, and this value is registered in the inventory information 205 for each of the goods type (Step s1203).

A comparison is made as to whether or not the number 703 of inventory goods based on the measured weight registered in the Step s1203 coincides with the number 704 of inventory goods in the plan described by the inventory information 205 for each of the goods type (Step s1204).

When the values do not match in the Step s1204, the fact that a discrepancy was detected, together with detailed information such as the type of goods, number of inventory goods based on measured result and number in the plan, are displayed on the manager's information terminal 130, and stocktaking work is terminated (Step s1206).

When the values do match in the Step s1204, the fact that the number of goods in the inventory matches the measured result and the number in the plan for this type of goods, is displayed on the manager's information terminal 130, and stocktaking work is terminated (Step s1207).

In the flowchart shown in FIG. 12, reading of the IDs of the goods is performed after measuring the gross weight of the goods, but the invention is not limited to this sequence. It will of course be understood that various modifications may be made to the extent that it can be verified that the measured number of inventory goods and the planned number of goods in the plan match during stocktaking work.

In the above, process flow details of the inspection, incoming, outgoing and stocktaking of goods were described.

The ID tag defined in this embodiment may be for example a card-like tag wherein ID information is indicated on the surface as a bar code, or an RFID tag wherein ID information is transmitted via wireless communication with the reader by an radio wave transceiver function.

Provided that the inspection point information terminal 103, information terminal 123 for incoming/outgoing goods workers or manager's information terminal 130 according to this embodiment has an information display function and a function for the user to input procedural details, there are no limitations on its shape, whether or not there is an external power supply, or the input means.

The communication pathway 150 defined in this embodiment may have the function of a pathway for transmitting information, and may be wireless, wired or a combination of both.

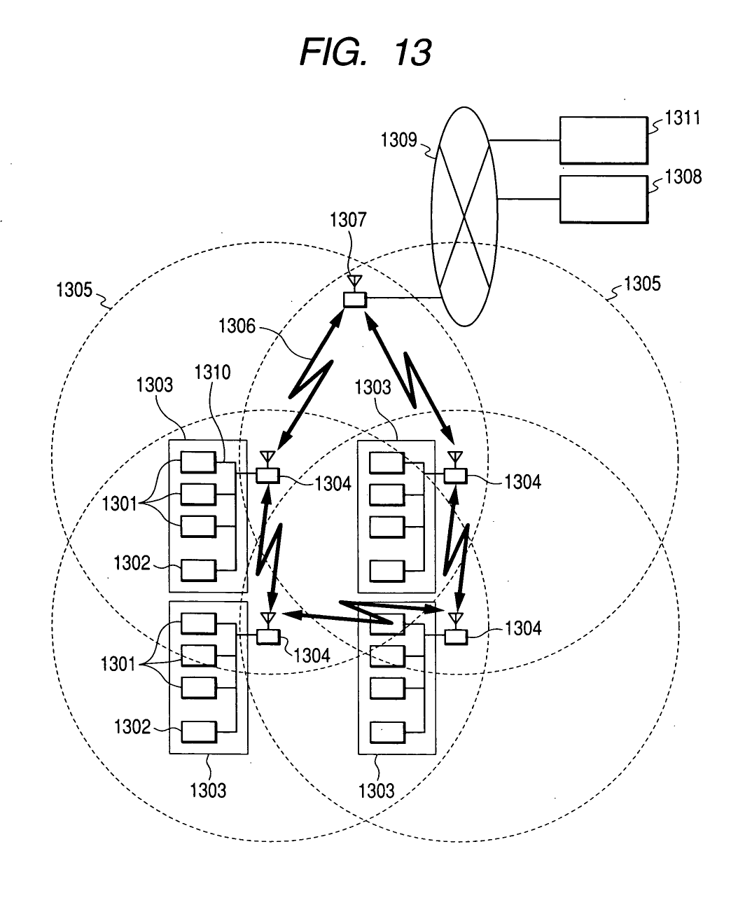

FIG. 13 is a figure showing the details of the communication pathway of this embodiment.

In a goods storage shelf 1303, one or more ID readers 1302 are connected to one or more weight sensors 1301 at a wireless communication node 1304 by a wired communication network 1310. The range 1305 of the wireless communication node 1304 wherein communication is possible, is shown by the dashed line in the figure. Each goods storage shelf 1303 has a relay function and together they form a multi-hop wireless communication network 1306, so information can be transmitted even to the wireless communication nodes 1304 which are not contained within the range 1305 via other wireless communication nodes.

A wireless communication base station 1307 linked to the wired communication network 1309 is contained in the wireless communication network 1306. A management server and terminal 1308, and weight sensor and ID reader 1311 in the inspection point, are connected to the wired communication network 1309, a local area network being formed by the interconnection of the wired and wireless networks.

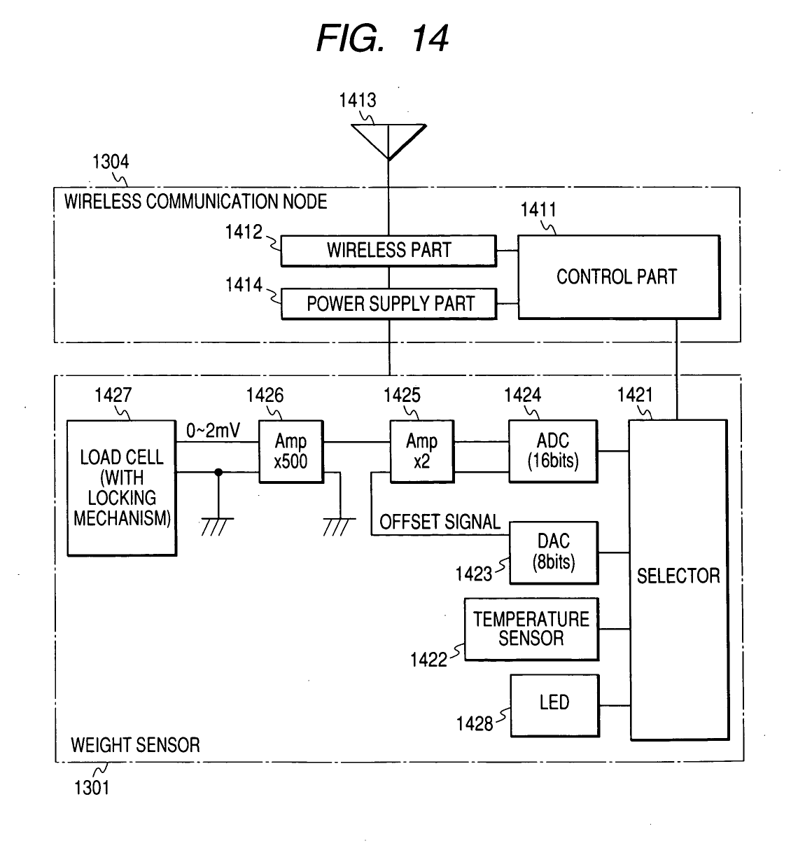

FIG. 14 is a figure showing the weight sensor of this embodiment, and the details of the wireless communication node.

The wireless communication node 1304 comprises a control part 1411, wireless part 1412 and power supplying part 1414. The wireless part 1412 is provided with an antenna 1413 so that information can be transmitted to and received from other wireless communication nodes or the wireless communication base station 1307.

The power supplying part 1414 may use a method which supplies power from outside, or a method which supplies power independently by a primary cell, secondary cell or power generating function.

The weight sensor 1301 comprises a selector 1421, temperature sensor 1422, DA converter 1423, AD converter 1424, amplifiers 1425, 1426, and load cell 1427.

The load cell deforms due to an external force by weight, a weak voltage is outputted, and amplified by amplifiers 1425, 1426. The output of the DA converter 1423 is inputted into the amplifier 1425 as an offset signal, the difference between this voltage and the signal obtained from the amplifier 1426 is amplified, and the result is inputted into the AD converter 1424.

In order to express measured values as digital values, the range of values in which these values can be expressed is the product of the quantization step of the AD converter 1424 and the number of output bits of the AD converter 1424. If the range of values is smaller than the range of possible measured values so that expression is not possible, the range of values which can be expressed is adjusted by changing the offset signal to a suitable value so as to include the measured values.

A selector 1421 is provided with an interface function with the wireless communication node 1304, the offset signal transmitted from the control part 1411 is outputted to a DA converter, a LED light ON/OFF signal transmitted from the control part 1411 is outputted to the LED 1428, and the weight measurement value and temperature obtained from the AD converter 1424 and temperature sensor 1422 are transmitted to the control part 1411.

The case in which goods are stored has a construction such that a load is not usually transmitted to the load cell 1427 due to a locking mechanism. When a worker presses a button to cancel the locking mechanism according to a message which specifies weight measurement, the load of the case is transmitted to the load cell and weight measurement starts. Simultaneously, an LED ON signal is transmitted to the LED 1428, and the LED 1428 starts to light. When the measured value is transmitted from the weight sensor 1301 to the control part 1411 and measurement is completed, an LED OFF signal is transmitted to the LED 1428 from the control part 1411, when the LED 1428 switches OFF the worker is notified that measurement is completed, and a message specifies operation of the locking mechanism again.

In this invention, the inventory volume of goods was specified and a weight sensor was used, but the invention is not limited thereto, and various modifications are possible within a range which does not deviate from the scope and spirit of the present application. For example, instead of the weight sensor, the inventory volume of the goods can be specified using a pressure sensor. The goods is also not limited to a solid, and may be a fluid or gas.

What is claimed is:

1. An incoming/outgoing goods management system comprising:
a first sensor which measures the amount of goods stored in a package to which a first ID tag is given;
a second ID tag carried by a worker;
an ID reader which reads package specific information in said first ID tag, and worker information in said second ID tag; and
an information processing part which stores a working plan;
wherein said package specific information is information which specifies the goods stored by said package, said worker information is information which shows a worker who is authorized to handle said goods, said information processing part receives input of the value of said measured amount, said read package specific information and said worker information, and said information processing part determines the compliance of the work which is in progress by comparing said work plan with the value of said inputted amount, said package specific information and said worker information.

2. The incoming/outgoing goods management system according to claim 1, wherein said information processing part creates a working command based on a determination of the compliance of said work.

3. The incoming/outgoing goods management system according to claim 1, wherein said information processing part:
determines an inventory volume of said goods based on the value of said amount, and said package specific information; and
when the inventory volume of said goods satisfies predetermined conditions, performs ordering of said goods.

4. The incoming/outgoing goods management system according to claim 1, further comprising an ID tag recovery container, wherein the ID tag stored in said ID tag recovery container prevents reading by said ID reader.

5. The incoming/outgoing goods management system according to claim 1, further comprising a second sensor, wherein:
said second sensor measures the weight of said package in advance of warehousing said goods; and
said information processing part matches and stores the weight of said package measured by said second sensor with unique information relating to said package.

6. The incoming/outgoing goods management system according to claim 5, wherein
said information processing part determines whether the weight of the package measured by said second sensor matches a range stored beforehand in said information processing part.

7. The incoming/outgoing goods management system according to claim 1, wherein said work is the incoming or outgoing processing of said goods.

8. The incoming/outgoing goods management system according to claim 1, wherein the value of said amount measured by said first sensor is the weight of said goods and said package combined.

9. An incoming/outgoing goods management method comprising:
measuring a value of amount of goods stored by a package to which a first ID tag is given;
reading package specific information in said first ID tag which specifies said goods;
reading worker information showing a worker who carries a second ID tag, and is authorized to handle said goods;
storing a working plan in an information processing part;
inputting a value of said measured amount, said package specific information and said worker information into said information processing part;
comparing said value of said amount, said package specific information and said worker information with a work plan; and
determining the compliance of the work which is in progress.

10. The incoming/outgoing goods management method according to claim 9, further comprising: creating a working command based on a determination of the compliance of said work.

11. The incoming/outgoing goods management method according to claim 9, further comprising:
determining an inventory volume of said goods based on the value of said amount, and said package specific information; and
when the inventory volume of said goods satisfies predetermined conditions, performing ordering of said goods.

12. The incoming/outgoing goods management method according to claim 9, further comprising:
preventing reading of an ID tag stored in an ID tag recovery container by said ID reader.

13. The incoming/outgoing goods management method according to claim 9, further comprising:
measuring the weight of said package by a second sensor in advance of warehousing said goods; and
storing the weight of a package measured by said second sensor with unique information relating to said package.

14. The incoming/outgoing goods management method according to claim 13, further comprising:
determining whether the weight of the package measured by said second sensor matches a range stored beforehand in said information processing part.

15. The incoming/outgoing goods management method according to claim 9, wherein said work is the incoming or outgoing processing of said goods.

16. The incoming/outgoing goods management method according to claim 9, wherein the value of said amount measured by said first sensor is the weight of said goods and said package combined.
